(19) United States
(12) Patent Application Publication
(10) Pub. No.: US 2021/0048005 A1
(43) Pub. Date: Feb. 18, 2021

(54) INTEGRATED WIND TURBINE POWERTRAIN LUBRICATION SYSTEM

(71) Applicant: Vestas Wind Systems A/S, Aarhus N. (DK)

(72) Inventor: Knud Erik Petersen, Holstebro (DK)

(73) Assignee: Vestas Wind Systems A/S, Aarhus N. (DK)

(21) Appl. No.: 16/969,313

(22) PCT Filed: Jan. 11, 2019
(86) PCT No.: PCT/DK2019/050010

§ 371 Date: Aug. 12, 2020

(30) Foreign Application Priority Data
Feb. 21, 2018 (DK) PA 2018 70113

(51) Int. Cl. F03D 80/70; F03D 15/00; F01M 11/00; F16N 7/40; F16N 13/20; F01M 1/12; F01M 1/02; F16N 31/00; F16H 57/02; F16H 57/04; F16C 33/10; H02K 7/116; H02K 7/18

(52) U.S. Cl. CPC F03D 80/70; F16C 2360/31; F01M 11/0004; F16N 7/40; F16N 13/20; F01M 1/12; F01M 1/02; F16N 31/002; F16H 57/02; F16H 57/0424; F16H 57/0436; F16C 33/1045; H02K 7/116; H02K 7/1838; F05B 2260/98; F05B 2260/40; F16N 2210/025; F01M 2001/126; F01M 2011/0083; F01M 2001/0253; F16N 2280/00; F16H 2057/02078; F03D 15/00

(57) ABSTRACT

A powertrain component (21, 22, 23) for a wind turbine (100) is provided, comprising a powertrain component housing (20) with at least one rotating part (49) and a dry sump 5 lubrication system for lubricating the rotating part (49). The lubrication system comprises a dry sump lubricant tank (51, 52, 53) and a pump (60) for pumping the lubricant from the tank (51, 52, 53) towards a lubricant release point, the lubricant release point being provided at a level above at least part of the rotating part (49) for receiving the lubricant from the tank (51, 52, 53) and allowing the lubricant to lubricate the rotating part (49). 10 The tank (51, 52, 53) is integrated in or directly attached to the powertrain component housing (20) at a level below the at least one rotating part (49).

### FIELD OF THE INVENTION

The invention relates to a powertrain component for a wind turbine, the powertrain component comprising a powertrain component housing with at least one rotating part and a dry sump lubrication system for lubricating the rotating part. The dry sump lubrication system comprises a dry sump lubricant tank, a lubricant release point and a pump. The tank is provided for containing a lubricant, and is provided at a level below the at least one rotating part. The lubricant release point is provided at a level above at least part of the rotating part for receiving the lubricant from the tank and allowing the lubricant to lubricate the rotating part. The pump is provided for, at least in an electricity producing mode of the wind turbine, pumping the lubricant from the tank towards the lubricant release point.

### BACKGROUND OF THE INVENTION

A wind turbine converts wind energy into electrical power using large rotor blades that cause a rotor hub to rotate at a speed that depends on the wind speed, the wind turbine design and its current configuration (blade pitch, yaw angle, generator torque). A powertrain transfers the rotation of the rotor hub to a rotation at an input of the generator. The optimal input speed for the generator is considerably higher than the usual and maximum rotational speed of the rotor blades. The powertrain typically comprises a gearbox for increasing rotational speed from the low-speed rotor at the gearbox input to a higher speed electrical generator at the gearbox output. In addition to the gearbox and the generator, the powertrain usually comprises one or more main bearings supporting the rotor hub and facilitating its rotation.

A common gearbox ratio is about 90:1, with the rotor at the input typically rotating at a speed up to 20 rpm and a corresponding 1800 rpm output for the generator. Usually, the gearbox comprises three consecutive stages. At the input, a planetary stage is provided which is very suitable for handling high torques from the rotor. The planetary stage is then followed by two consecutive parallel stages having sets of gears that further speed up the rotation. Alternatively, also the second stage uses a planetary gear set and only the third stage is a parallel stage. Some wind turbines may use lower gearbox ratios, e.g. about 30:1, dispensing with the highest speed stage in a typical gearbox.

Lubrication of critical powertrain components is important for ensuring their function. In general, two types of lubrication systems are currently employed. In wet sump lubrication systems, the lubricant is contained in the powertrain component itself and the rotating parts are lubricated while they rotate through the lubricant. In dry sump lubrication systems, a dry sump lubricant tank is provided at a level below the at least one rotating part and a pump is used for pumping the lubricant to the lubricant release point. Dry sump lubrication systems have some important advantages over wet sump systems, such as improved oil temperature control and reduced mechanical resistance in the rotating parts.

For example, known wind turbine gearboxes with dry sump lubrication systems use an external lubricant tank and an electrically driven pump to pump lubricant into the gearbox during operation. The lubricant is usually some type of oil, but other types of fluids may be equally suitable for lubricating the rotating gearbox parts. The external lubricant tank is provided at a level below the gearbox. In all present day dry sump lubrication systems, the lubricant tank is a separate reservoir, fluidly connected to a gearbox drain via pipes or hoses. In operation, the lubricant is pumped from the lubricant tank to a level above the gearbox. Gravity pulls the lubricant through the gearbox and its rotating elements, back to the lubricant tank. A filter system may be added to the lubrication system ensure that the lubricant is kept clean of dirt. In the event of a grid failure, no electrical power can be provided to the lubricant pump. For such emergency situations, a second lubricant tank is provided at a level above the gearbox. In the event of a grid failure, the lubricant from this second tank is used for flooding the gearbox and the gearbox lubrication system will temporarily function in a wet sump configuration. When normal operation is resumed, the excess lubricant is released from the gearbox and pumped up to the second tank again.

The US patent application published as US 2013/0343888 discloses a wind turbine gearbox with an electronically controllable pump for providing lubricant to bearings and gears in the gearbox. The lubricant system further comprises a sump filled with the lubricant to be pumped into the gearbox. The patent application describes a possibility to operate the lubrication system in either a dry sump or wet sump mode. In the wet sump mode, the gear system is flooded in lubricant and the gears rotate through the lubricant. In this configuration, the gearbox forms its own lubrication tank. When turning to the dry sump mode, the lubricant is drawn out of the gear system and stored in the external tank.

The rotating elements in the gearbox can then run freely, without having to drag through the lubricant. This has the advantage that less friction occurs as a result of the lubrication process, thereby reducing the losses introduced in the gear system and improving its efficiency.

Not only the gearbox, but also the other powertrain elements, typically the main bearings and the generator, need lubrication. With a trend of wind turbines getting larger and more complex every year, there is a large need for more compact and robust designs and a drive for reducing the amount of parts in a wind turbine without limiting the performance, power output and reliability of the wind turbine. It is therefore the object of the invention to improve the design of the wind turbine powertrain lubrication system in at least one of the above mentioned aspects.

### SUMMARY OF THE INVENTION

According to the invention this object is achieved by providing a powertrain component for a wind turbine with a powertrain component housing, at least one rotating part and a dry sump lubrication system for lubricating the rotating part. The lubrication system comprises a dry sump lubricant tank for containing a lubricant. The tank is integrated in or directly attached to the powertrain component housing at a level below the at least one rotating part. A pump is provide for pumping the lubricant from the tank towards a lubricant release point, which is provided at a level above at least part of the rotating part for receiving the lubricant from the tank and allowing the lubricant to lubricate the rotating part.

With the lubrication system according to the invention, there is no need for accommodating a separate dry sump lubricant tank in the nacelle and less pipes or hoses have to be provided for allowing the lubricant to flow from the powertrain components back to the lubricant tank. This solution will therefore lead to a reduced number of parts, lower costs, more compact design and less points of possible failure. In addition thereto, combining the gearbox and the lubricant tank in a single unit makes it possible to provide the pump in or very close to the tank, e.g. inside the housing of the powertrain component. Again this will allow a more compact design with fewer and shorter hoses for transporting the lubricant from the tank to the lubricant release point.

The tank is integrated in, or directly attached to, only one of the powertrain components, or different powertrain components may each have their own dedicated tank. When multiple tanks are used, they may be fluidly connected, such that not every tank needs its own pump.

It is to be noted that ‘tank’ here means that it is the main reservoir containing the greater part of the lubricant that is not currently lubricating the rotating parts and from which the pump pumps up the lubricant that is to be led to lubricant release point. For example, a small sump in the bottom of the gearbox housing, where lubricant is collected before pipes and hoses bring it to the main tank, cannot considered to be a dry sump lubricant tank as claimed herein.

The pump may be a standard electrical pump or a mechanical pump, operatively connected to the rotating part for being mechanically driven thereby for, at least in an electricity producing mode of the wind turbine, pumping the lubricant from the tank towards the lubricant release point.

It is noted that it is known to supply an auxiliary mechanically driven external pump in addition to an electrically driven pump. The purpose of such an auxiliary pump is then to provide lubricant to the gearbox when the wind turbine is idling and does not produce any electricity for operating the electrically driven lubricant pump that is used during normal operation. The use of a mechanical pump during normal operation of the wind turbine has, however, not been considered before.

According to the present invention, the mechanical pump is also used for lubricating the rotating parts of the powertrain components when the wind turbine is delivering electricity in a normal operational mode. As a consequence, no electrical pump is needed, which does further simplify design and reduce costs. A mechanical pump continues pumping lubricant around as long as the parts in the gearbox rotate. Further, an electrically driven pump consumes power whereas a mechanically driven pump is operated for free during idling. Over the lifetime of the turbine, this sums up to quite an amount of saved energy and money.

Optionally, an auxiliary relatively small and lower capacity electrical pump may be provided for lubricating the rotating parts of the power train components when the rotor of the wind turbine is stopped.

The tank may be integrated in the powertrain component housing. ‘Integrated’ herein means that the housing of the tank is integrally formed with the housing of the gearbox. This can, e.g., be achieved by extending the housing further down below the lowest level of the gears and other rotating parts of the powertrain component. The tank and gearbox housing may be formed as a single piece, or the tank may, e.g., be permanently fixed to the gearbox by welding. ‘At a level below’ herein means that, in normal operation, the lubricant level in the tank is lower than said rotating part. Portions of the housing or other parts of the tank that are situated above the lubricant level may still be at a higher level. Therefore, the ‘level of the tank’ is to be interpreted as the maximum lubricant level in normal use. When filling the tank with lubricant up to the appropriate level, it can be avoided that lubricant splashes back into the gears and bearings, e.g. during tower movement in windy conditions. Baffle plates may be added to the internal walls of the tank at those positions where the lubricant flows into the tank, e.g. just above a stage drain where lubricant from adjacent gearbox stages is released into the tank or just above an opening where lubricant coming from the tank of a different powertrain component enters the housing.

Although completely integrating the tank into the powertrain component may lead to the most compact design and the least amount of separate parts, it may complicate the assembly of the powertrain component and the replacement of specific parts upon a possible failure. Therefore, in an embodiment of the powertrain component according to the invention, the tank is directly attached to the powertrain component housing. For example, the tank may be bolted onto the bottom of a powertrain component housing, to a lower part of its sidewalls or to some mounting structures at the powertrain component housing, specifically provided for that purpose.

When a separate lubricant tank is directly attached to the powertrain component housing, it may comprise a unit drain. The unit drain is provided in the powertrain component housing at a level below the lubricant release point and below at least part of the rotating part, and is in direct fluid communication with the tank for allowing the lubricant to flow from the powertrain component into the tank.

In this context, ‘in direct fluid communication’ means without the need of any hoses running outside the powertrain component and tank housing, preferably without any hoses at all. The lubricant flows through the unit drain and falls directly into the tank that is attached thereto.

As discussed above in relation to the prior art, most wind turbine gearboxes comprise multiple gearbox stages. A fully integrated lubricant tank will have to be integrated in one of the gearbox stages, but stage drains may allow lubricant from the other stages to flow into the tank. Such stage drains are preferably provided in the internal walls of the gearbox, but may also comprise an external conduit (e.g. a hose or pipe) leading to the lubricant tank. Alternatively, other stages may have their own dedicated lubricant tank, but then also an additional pump may be needed for pumping the lubricant from that tank to the lubricant release point of the respective gearbox stage.

As a further option, the tank may be attached to a bottom part of the first one and to a bottom part of a second one of the gearbox stages. With similar result, the tank may, e.g., be attached to a lower part of the gearbox housing sidewalls, with the lubricant level, at least in normal operation, keeping below the gearbox housing. When the tanks is directly attached to two gearbox stages, each stage may have a gearbox drain that directly leads into the tank. In this context, the terms ‘first’ and ‘second’ are only used to identify the respective individual gearbox stages and have no relation to their relative position in the gearbox. The first gearbox stage may or may not be situated closer to the gearbox input shaft than the second gearbox stage and it is possible that additional gearbox stages are provided in between the two.

It will be appreciated that preferred and/or optional features of the first aspect of the invention may be combined with the other aspects of the invention. The invention in its various aspects is defined in the independent claims below and advantageous features are defined in the dependent claims below.

### BRIEF DESCRIPTION OF THE DRAWINGS

For a better understanding of the invention, some embodiments of the invention will now be described with reference to the following drawings, in which:

FIG. 1 schematically shows a wind turbine in which the current invention could be advantageously used.

FIG. 2 schematically shows the nacelle of a wind turbine in which the invention is used.

FIG. 3 schematically shows a side view of a three stage wind turbine gearbox according to the invention.

FIG. 4 shows a cross section of the gearbox of FIG. 3.

FIG. 5 shows a rear end view of the gearbox of FIG. 3

### DETAILED DESCRIPTION

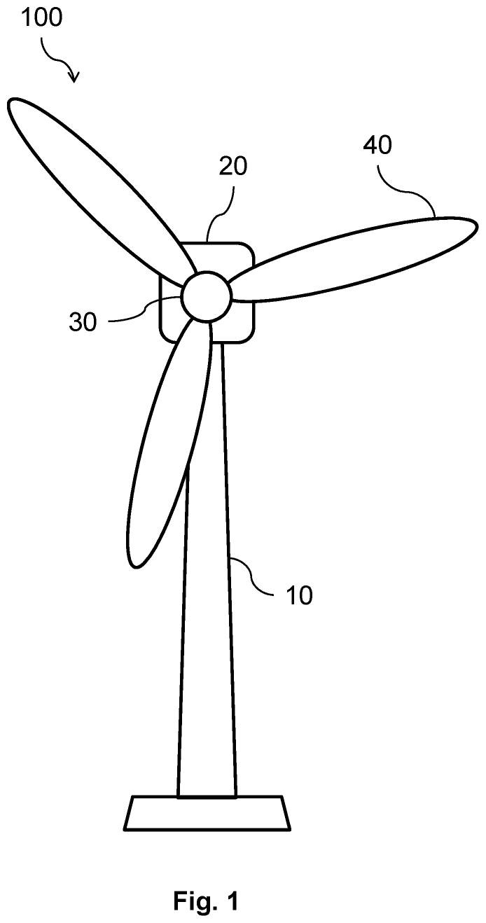

FIG. 1 schematically shows a wind turbine 100 in which the current invention could be advantageously used. The wind turbine 100 comprises a tower 10 with on top thereof a nacelle 20, comprising many of the functional parts of the wind turbine 100. A rotor hub 30 is rotatably mounted to the front end of the nacelle 20 and carries a number of rotor blades 40. The wind turbine 100 shown here comprises three rotor blades 40, but wind turbines with more or less rotor blades 40 are also possible.

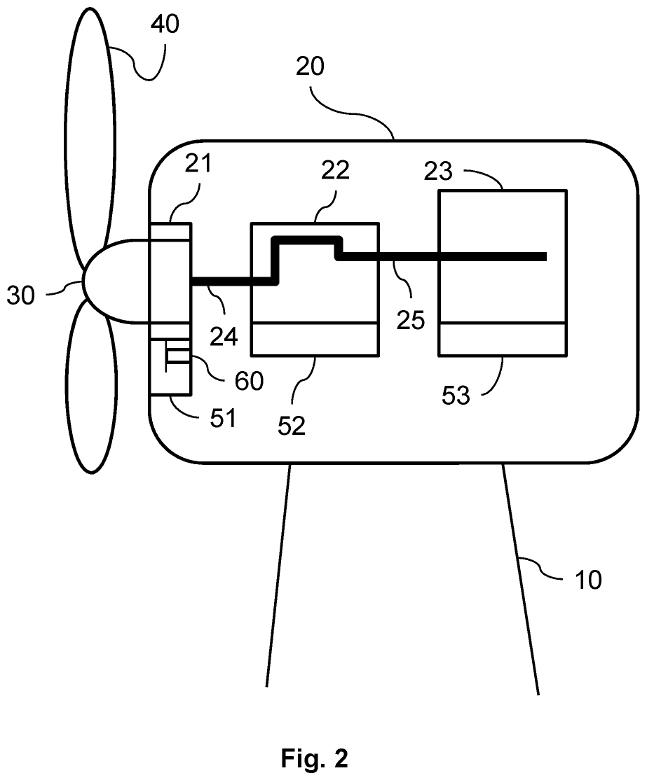

FIG. 2 schematically shows the nacelle 20 of a wind turbine 100 in which the invention is used. In operation, wind causes the rotor blades 40 and the rotor hub 30 to rotate. A powertrain, being enclosed by the nacelle 20 converts the rotation of the rotor hub 30 into electrical power. Power cables (not shown) run from the powertrain, down through the tower 10, to the ground, where the electrical power may be used, stored in a battery or transferred to an electrical grid. The powertrain of this wind turbine 100 comprises a main bearing 21, provided for supporting the rotor hub 30 and facilitating its rotation. An output shaft 24, rotating together with the rotor hub 30, forms the input of a subsequent gearbox 22. In the gearbox 22, the rotational speed of the low-speed rotor hub 30 at the gearbox input is converted into a higher rotational speed for the electrical generator 23 at the gearbox output. The electrical generator 23 turns the rotary power of the gearbox output shaft 25 into useful electrical power that can then be transported down through the wind turbine tower 10.

Lubrication of critical powertrain components is important for ensuring their function. In dry sump lubrication systems as used in the current invention, a lubricant tank 51, 52, 53 is provided at a level below the rotating parts of the respective powertrain components and a pump 60 is used for pumping the lubricant to the respective lubricant release points. In this exemplary embodiment, a pump 60 is provided in the tank 51 of the main bearing. The gearbox tank 52 and the generator tank 53 may each embody their own pumps (not shown), or receive their lubricant from the pump 60 in the main bearing tank 51 via pipes or hoses (not shown) provided for that purpose. If only one pump 60 is used, also the tanks 51, 52, 53 of the different powertrain components should be fluidly connected via hoses or pipes (not shown). In such a situation, it is preferable to have the pump 60 in the lowest positioned tank 51, such that the lubricant from the other tanks 52, 53 will be led there by gravity only.

The lubricant tanks 51, 52, 53 may be fully integrated in the housings of the powertrain components or directly attached to their bottoms. With a fully integrated tank 51, 52, 53, the lubricant can flow down through the lubricated parts and directly drop down into the tank 51, 52, 53. Optionally, some flow guiding features are added for directing the lubricant flow and avoiding lubricant from the tank 51, 52, 53 to splash up into the functional parts of the powertrain component.

Alternatively, the lubricant tanks 51, 52, 53 are directly attached to the bottom of the powertrain component housings. In such a configuration, it is preferred to have a unit drain in the bottom of the powertrain component housings through which the lubricant can fall down into the attached tank 51, 52, 53. The unit drain may comprise a controllable valve. Closing off the valve would allow the lubricant level in the powertrain component to rise in order to temporarily create a wet sump lubrication system, which may be desirable when in certain specific conditions.

The pump 60 may be a standard electrical pump or a mechanical pump 60, operatively connected to and powered by the rotating part of the power train component. For example, a mechanical pump 60 in the main bearing unit 21 could be driven by the rotary motion of the rotor hub 30 or a mechanical pump in the generator housing 23 could be driven by gears that are rotated by the generator input shaft 25. Because, according to the invention, the lubricant tank is integrated in or directly attached to the powertrain component, the mechanical pump 60 can be installed close to the rotating parts that power it as well as to the lubricant it has to pump up to the lubricant release points. With a separate lubricant tank as used in the prior art, a pump at the tank cannot easily be mechanically driven and a pump at the powertrain component needs long connecting pipes or hoses to pump the lubricant from the tank. The main advantage of using a mechanical pump 60 instead of an electrical one is that it doesn't consume any power when the wind turbine is idling and even works when the wind turbine loses its connection to the power grid. The lubrication system according to the invention does not need an electrical pump for normal operation, i.e. when the blades are rotating and the generator 23 produces electricity, or when idling. Optionally, a small auxiliary electrical pump may be provided for lubricating the powertrain components when the wind turbine is at a complete standstill.

The pump 60 may be installed inside the housing of the powertrain component 21, 22, 23, such that it closest to the gears driving the pump and the lubricant to be pumped up. Alternatively, the pump 60 may be attached to the housing of the powertrain component, such that it is easier accessible for maintenance.

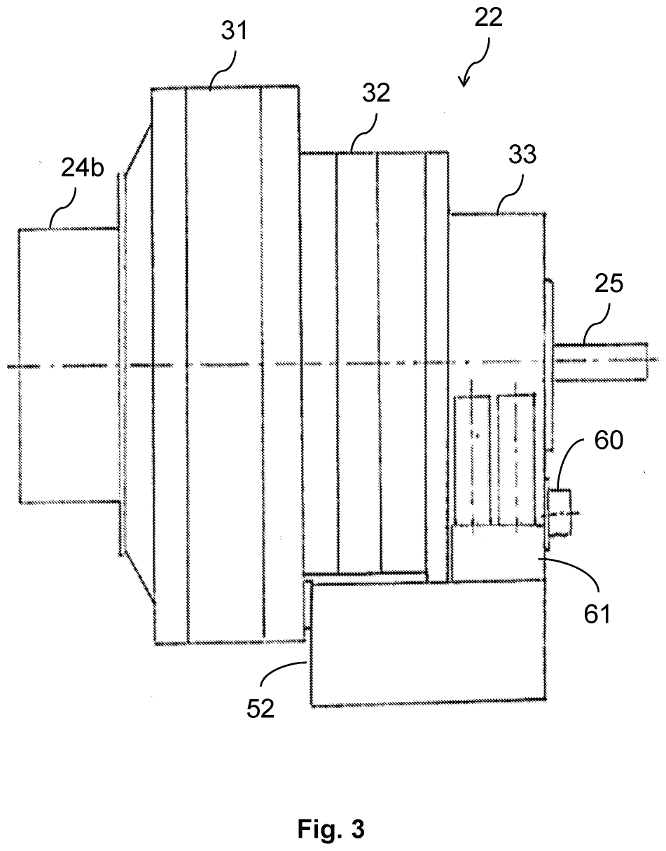

FIG. 3 schematically shows a side view of a three stage wind turbine gearbox 22 according to the invention. The rotor hub output shaft 24 forms or is connected to the input 24b of the gearbox 22. The gearbox 22 comprises three consecutive stages 31, 32, 33. A common gearbox ratio is about 90:1, with the rotor hub 30 at the input 24b typically rotating at a speed up to 20 rpm and a corresponding 1800 rpm output for the generator 23. Usually, the gearbox 22 comprises three consecutive stages 31, 32, 33. At the input 24b, a planetary stage 31 is provided which is very suitable for handling high torques from the rotor 30. The planetary stage 31 is then followed by two consecutive parallel stages 32, 33 having sets of gears that further speed up the rotation. Alternatively, also the second stage 32 uses a planetary gear set and only the third stage 33 is a parallel stage. Some wind turbines may use lower gearbox ratios, e.g. about 30:1, dispensing with the highest speed stage in a typical gearbox.

In this gearbox 22, a lubricant tank 52 is provided under the second and third gearbox stages. A mechanical pump 60 is provided in the gearbox housing. A filter arrangement 61 may be provided in between the lubricant tank 52 and the mechanical pump to ensure that only clean lubricant will be used for lubricating the rotating parts of the gearbox 22.

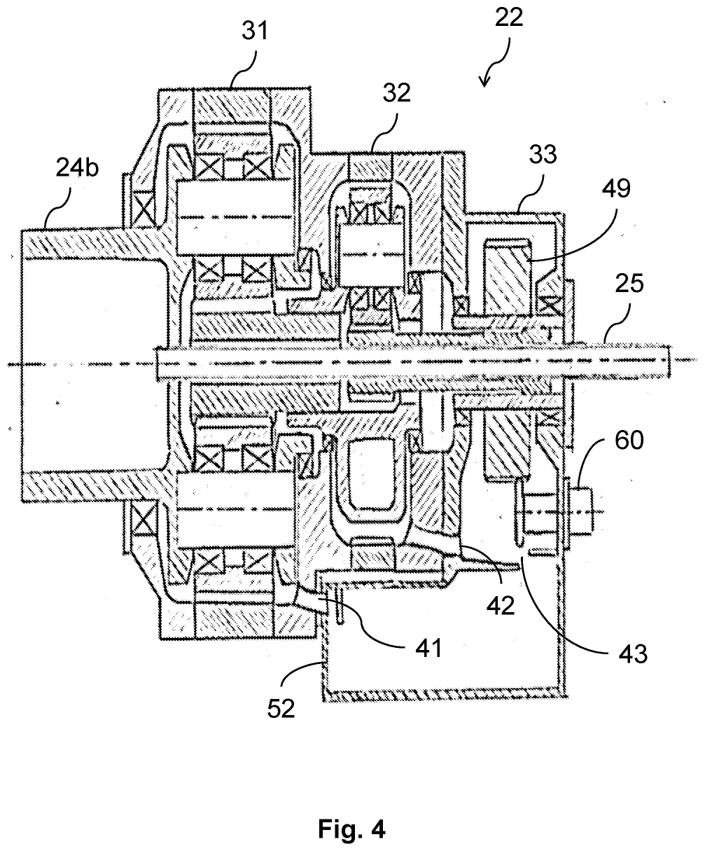

FIG. 4 shows a cross section of the gearbox 22 of FIG. 3. In this cross section, it is shown how the mechanical pump 60 is driven by a gear 49 in the third stage 33 of the gearbox 22. Also visible are the drains 41 and 43 of the first and third gearbox stages that let the lubricant from the respective gearbox stages flow into the tank 52 directly. Lubricant from the second gearbox stage 32 leaves that stage through a stage drain 42 that releases the lubricant in a lower part of the third gearbox stage 33. From there, it can flow through the drain 43 of the third gearbox stage into the tank 52.

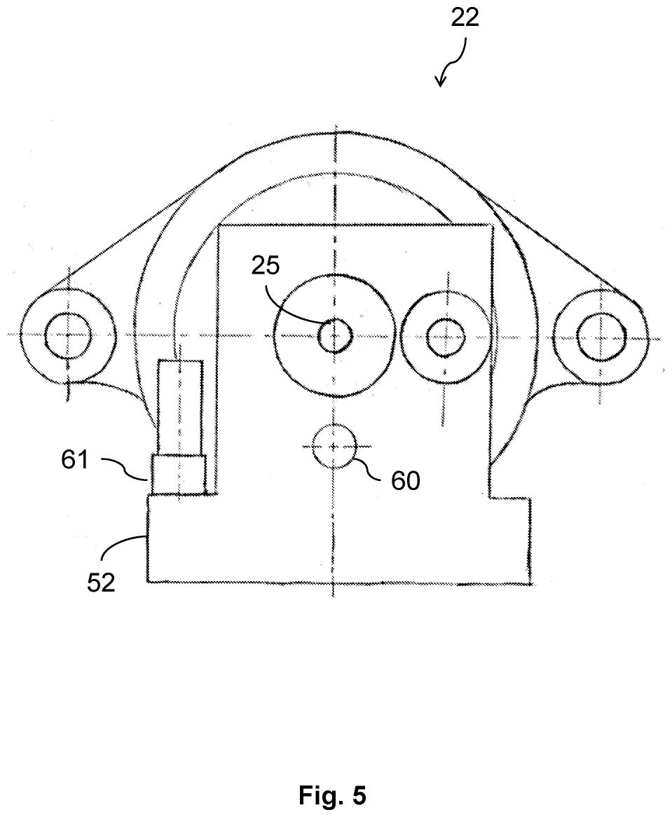

FIG. 5 shows a rear end view of the gearbox of FIG. 3. The lubricant tank 52 is shown here as a fully integrated feature of the gearbox housing, but it should be clear from the above that alternative arrangements are also possible. The exemplary tank 52 shown in FIGS. 3 and 4 has a length that is about twice the size of its height. From FIG. 5, it is clear that the width of the tank 52 may extend beyond the width of the main part of the gearbox, comprising the rotating parts. An alternative gearbox design may extend over the full length of the three gearbox stages 31, 32, 33. The resulting larger surface area would allow for a reduced height and therefore possibly a more compact design.

1. A powertrain component for a wind turbine, the powertrain component comprising a powertrain component housing with at least one rotating part and a dry sump lubrication system for lubricating the rotating part, the lubrication system comprising:
a dry sump lubricant tank, the tank being integrated in or directly attached to the powertrain component housing at a level below the at least one rotating part,
a pump for pumping the lubricant from the tank towards a lubricant release point, the lubricant release point being provided at a level above at least part of the rotating part for receiving the lubricant from the tank and allowing the lubricant to lubricate the rotating part.

2. The powertrain component as claimed in claim 1, wherein the pump is a mechanical pump, operatively connected to the rotating part for being mechanically driven thereby for, at least in an electricity producing mode of the wind turbine, pumping the lubricant from the tank towards the lubricant release point.

3. The powertrain component as claimed in claim 1, wherein the powertrain component is a rotor main bearing, a gearbox or a generator.

4. The powertrain component as claimed in claim 1, wherein the tank is directly attached to the powertrain component housing, further comprising a unit drain, provided in the powertrain component housing at a level below the lubricant release point and below at least part of the rotating part, the unit drain being in direct fluid communication with the tank for allowing the lubricant to flow from the powertrain component into the tank.

5. The powertrain component as claimed in claim 4, wherein the unit drain comprises a valve for selectively closing off the route for the lubricant into the tank.

6. The powertrain component as claimed in claim 1, wherein the powertrain component is a gearbox comprising at least two gearbox stages, each gearbox stage having at least one rotating part, the tank being attached to a bottom part of a first one of the gearbox stages.

7. The gearbox as claimed in claim 6, the tank being attached to a bottom part of the first one and to a bottom part of a second one of the gearbox stages.

8. The gearbox as claimed in claim 6, further comprising a gearbox drain, provided in a housing of the first gearbox stage at a level below the lubricant release point and below at least part of the respective rotating part, the gearbox drain being in direct fluid communication with the tank for allowing the lubricant to flow from the first gearbox stage into the tank.

9. The gearbox as claimed in claim 8, further comprising a second gearbox drain, provided in a housing of the second gearbox stage at a level below the lubricant release point and below at least part of the respective rotating part, the second gearbox drain being in direct fluid communication with the tank for allowing the lubricant to flow from the second gearbox stage into the tank.

10. The powertrain component as claimed in claim 1, wherein the powertrain component is a gearbox comprising at least two gearbox stages, each gearbox stage having at least one rotating part, the tank being integrated in a first one of the gearbox stages.

11. The gearbox as claimed in claim 6, further comprising a stage drain, provided in a housing of the second gearbox stage at a level below the lubricant release point and below at least part of the respective rotating part, the stage drain being in direct fluid communication with the first gearbox stage for allowing the lubricant to flow from the second gearbox stage into the first gearbox stage

12. The powertrain component as claimed in claim 1, wherein the mechanical pump is provided inside the powertrain component housing.

13. The powertrain component as claimed in claim 1, wherein the mechanical pump is configured to also pump the lubricant from the tank towards the lubricant release point when the wind turbine is in an idling mode.

14. The powertrain component as claimed in claim 1, further comprising an electrically powered lubricant pump for pumping the lubricant from the tank towards the lubricant release point when the wind turbine is at a standstill.
